(19) United States
(12) Patent Application Publication
(10) Pub. No.: US 2025/0342393 A1
(43) Pub. Date: Nov. 6, 2025

(54) SELF-CORRECTING PROTOTYPE-BASED LEARNING FRAMEWORK FOR DEBIASING TRAINING DATA

(71) Applicant: NEC Laboratories Europe GmbH, Heidelberg (DE)

(72) Inventors: Kiril Gashteovski, Heidelberg (DE); Sascha Saralajew, Heidelberg (DE)

(21) Appl. No.: 18/782,168

(22) Filed: Jul. 24, 2024

Related U.S. Application Data
(60) Provisional application No. 63/642,910, filed on May 6, 2024.

(51) Int. Cl. G06N 20/00

(52) U.S. Cl. CPC G06N 20/00

(57) ABSTRACT

A prototype-based model with one prototype per class is analyzed based on a comparison between a class-wise quality metric and a threshold for each prototype per class pair. A new prototype is added for each class in response to the class-wise quality metric for a respective prototype per class pair being below the threshold. The prototype-based model is retrained using the new prototype. A number of training samples closest to each prototype per class pair of the retrained prototype-based model is counted based on a distance measure. Sample weights for the training samples closest to each prototype per class pair is computed based on the number. A target model is trained using the computed sample weights. The method has applications including, but not limited to, use cases in computational biology, medical AI and healthcare, and cyber threat security for optimizing machine learning processes or supporting decision making.

### CROSS-REFERENCE TO PRIOR APPLICATION

Priority is claimed to U.S. Provisional Application Ser. No. 63/642,910 filed on May 6, 2024, the entire contents of which is hereby incorporated by reference herein.

### FIELD

The present disclosure relates to Artificial Intelligence (AI) and machine learning (ML), and in particular to a method, system, data structure, computer program product and computer-readable medium for debiasing training data, training a machine learning model and/or a prototype-based learning methods, and corresponding trained models and prototype-based learning systems.

### BACKGROUND

One major application of machine learning is to classification problems. For example, based on patient health record data, a possible task could be the classification of whether a patient has a high risk to develop a cardiovascular disease. For this task, machine learning models are trained on available patient data. One technical problem in this domain, among others, is the training of bias free models. A model is biased if it performs unintentionally different on certain subgroups of the data. For instance, if the health record data is mainly based on Caucasians and just a minority in the dataset are people of color, it is likely that the model performs worse on people of color, leading to an unintended discrimination. For example, one study observed that “American Indians develop type 2 diabetes at nearly twice the rate Caucasians do. Latinos, Asians, and African Americans are also at higher risk” (Good to Know: Race and Type 2 Diabetes. Clin Diabetes. 2020 October; 38(4):403-404. doi: 10.2337/cd20-pe04. PMID: 33132511; PMCID: PMC7566924). In this particular example, if training a model to diagnose type 2 diabetes, and the training data is consisted of mostly Caucasians, then the model will perform less accurately for American Indians, African Americans, Latinos and Asians, even though these are the groups of people that are the most vulnerable to this disease. The problem with biased models that are the result of a biased training dataset is that it is difficult to identify biases in the dataset as they are usually not as obvious as described in this example. The next problem is that even if the biasing factors are known, such as people of color are underrepresented, it is difficult to control them.

One well-known solution to the technical problem of avoiding biased models if the dataset is biased is to perform the model training with a weighted sampling. This means that samples of underrepresented groups are presented during training with a higher probability. However, one technical challenge of this method is how to choose the sampling weights respectively.

### SUMMARY

In an embodiment, the present disclosure provides a computer-implemented method for training of a machine learning model. A prototype-based model with at least one prototype per class is analyzed based at least in part on a comparison between a class-wise quality metric and a threshold for each prototype per class pair of the prototype-based model. A new prototype is added for each class in response to the class-wise quality metric for a respective prototype per class pair being below the threshold. The prototype-based model is retrained using the new prototype. A number of training samples closest to each prototype per class pair of the retrained prototype-based model is counted based on a distance measure. Sample weights for the training samples closest to each prototype per class pair is computed based on the number. A target model is trained using the computed sample weights. The method has applications including, but not limited to, use cases in computational biology, medical AI and healthcare, and cyber threat security for optimizing machine learning processes or supporting decision making.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 schematically illustrates a method and an overall system architecture for debiasing training data a training and evaluating a bias-free model according to an embodiment of the present disclosure;

FIG. 2 schematically illustrates a method and system for debiasing training data using prototypes according to an embodiment of the present disclosure;

FIG. 3 schematically illustrates a method and system for disease classification from training data including medical records of patients using prototypes according to an embodiment of the present disclosure;

FIG. 4 schematically illustrates a method and system for cyberthreat level classification from training data including cyberthreat security descriptions using prototypes according to an embodiment of the present disclosure; and

FIG. 5 is a block diagram of an exemplary processing system, which can be configured to perform any and all operations disclosed herein.

### DETAILED DESCRIPTION

Embodiments of the present disclosure provide solutions to the technical problem of avoiding bias in trained models, and the other technical problems/challenges discussed above, by learning a prototype model with an adaptive number of prototypes to identify subgroups in the dataset (groups that might lead to biases in the model). Moreover, the learned prototypes can determine the sampling weights for the training procedure of the final model.

Embodiments of the present disclosure address the technical problem that raw data, in particular, that is collected in the wild, or from unreliable sources, comes with inherent and sometimes unknown biases, and also address the technical challenges that arise from such biases. When trained models on such biased data are deployed, such biases might turn out to be critical for the well-being of humans. For example, data might contain certain biological biases (e.g., genetic biases or socio-economic biases of the people) that are not applicable to particular patients, thus leading to either a false diagnosis, or worse, false treatment. To mitigate such biases in training data, embodiments of the present disclosure provide an automatic preprocessing step based on prototype-based classification learning to determine, for each sample, a sampling weight such that an unbiased training of the target model can be performed. Moreover, these weights can be used to perform an unbiased evaluation of the target model performance.

In a first aspect, the present disclosure provides a computer-implemented method for training of a machine learning model. A prototype-based model with at least one prototype per class is analyzed based at least in part on a comparison between a class-wise quality metric and a threshold for each prototype per class pair of the prototype-based model. A new prototype is added for each class in response to the class-wise quality metric for a respective prototype per class pair being below the threshold. The prototype-based model is retrained using the new prototype. A number of training samples closest to each prototype per class pair of the retrained prototype-based model is counted based on a distance measure. Sample weights for the training samples closest to each prototype per class pair is computed based on the number. A target model is trained using the computed sample weights.

In a second aspect, the present disclosure provides the method according to the first aspect, wherein computing the sample weights for the training samples is further based on an equation including:

$$p ( k , c ) = \frac{1}{C} \cdot \frac{1}{K ( c )} \cdot \frac{1}{M ( k , c )} ,$$

where C is a number of classes, K(c) is a number of prototypes in class c, M(k,c) is a number of training samples in the class c with respect to prototype k, and p(k,c) is the sample weights.

In a third aspect, the present disclosure provides the method according to the first aspect or the second aspect, wherein analyzing, adding, and retraining steps are iteratively repeated until the class-wise quality metric for each prototype per class pair of the retrained prototype-based model exceeds the threshold.

In a fourth aspect, the present disclosure provides the method according to any of the first to third aspects, wherein the prototype-based model is initially trained with a set of training data for a classification task, wherein the training samples are derived from the set of training data, and wherein training the target model using the computed sample weights includes using the set of training data.

In a fifth aspect, the present disclosure provides the method according to any of the first to fourth aspects, wherein the class-wise quality metric is computed on a hold-out dataset.

In a sixth aspect, the present disclosure provides the method according to any of the first to fifth aspects, further comprising performing a weighted sampling of the trained target model using the computed sample weights.

In a seventh aspect, the present disclosure provides the method according to any of the first to sixth aspects, further comprising determining an unbiased performance metric using the computed sample weights.

In an eighth aspect, the present disclosure provides the method according to any of the first to seventh aspects, further comprising measuring bias performance on a set of training data using the unbiased performance metric, wherein the set of training data is used for initially training the prototype-based model, wherein the bias performance includes a biasness score per class of the set of training data.

In a ninth aspect, the present disclosure provides the method according to any of the first to eighth aspects, wherein the retrained prototype-based model identifies subgroups in a set of training data.

In a tenth aspect, the present disclosure provides the method according to any of the first to ninth aspects, further comprising generating a report that includes learned prototypes and identified subgroups of the learned prototypes of the trained target model

In an eleventh aspect, the present disclosure provides the method according to any of the first to tenth aspects, further comprising, prior to retraining the prototype-based model using the new prototype, re-initializing the prototype-based model.

In a twelfth aspect, the present disclosure provides the method according to any of the first to eleventh aspects, further comprising receiving medical records of patients, wherein the prototype-based model is initially trained using the medical records of patients, and wherein the trained target model identifies disease classifications in the medical records of patients.

In a thirteenth aspect, the present disclosure provides the method according to any of the first to twelfth aspects, further comprising receiving descriptions of cyber threat security issues, wherein the prototype-based model is initially trained using the descriptions of cyber threat security issues, and wherein the trained target model identifies threat level classifications for each cyber threat security description of the descriptions of cyber threat security issues.

In a fourteenth aspect, the present disclosure provides a computer system for training of a machine learning model comprising one or more processors which, alone or in combination, are configured to perform a machine learning method for training of a machine learning model according to any of the first to thirteenth aspects.

In a fifteenth aspect, the present disclosure provides a tangible, non-transitory computer-readable medium for training of a machine learning model which, upon being executed by one or more hardware processors, provide for execution of a machine learning method according to any of the first to thirteenth aspects.

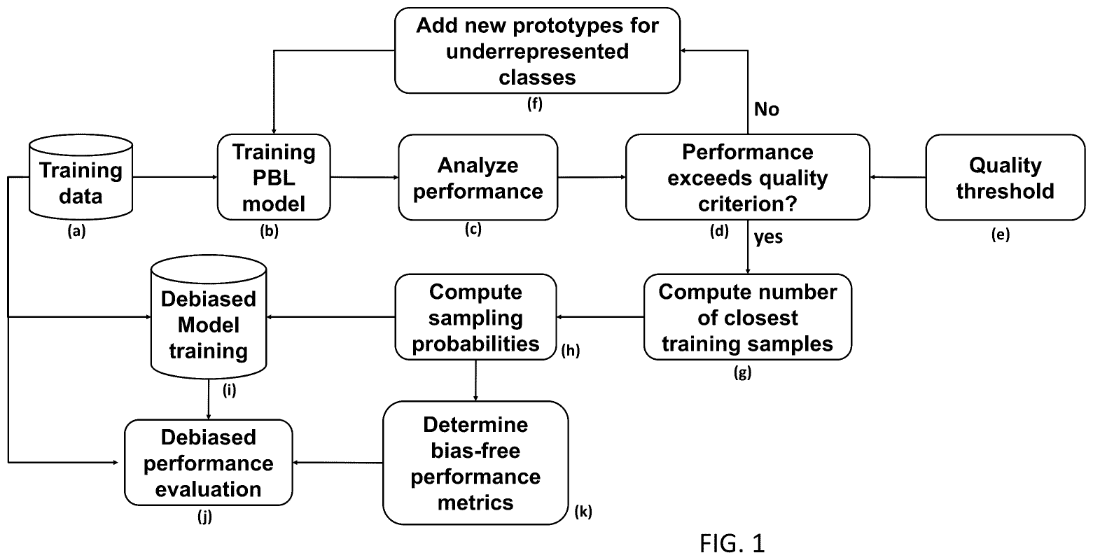

Referring to FIG. 1, before training the final model on the available dataset (see training data (a) in FIG. 1), which is potentially a powerful model like a deep neural network so that the model is sensitive to biases in the dataset, a prototype-based classifier is trained as a simple and robust surrogate on the classification task (see training prototype-based learning (PBL) model (b) in FIG. 1). Such classification task can be, for example, classification of a patient for type 2 diabetes. Starting with the simplest case, which is a prototype-based classifier with one prototype per class (prototypes are trainable parameter vectors defined in the input space); e.g., one prototype (a patient) per class (“has type 2 diabetes”). Plain prototype-based models are also denoted as weak learners as they often do not achieve a satisfactory performance. However, they are able to identify robust positions in the dataset so that a good representation of the dataset is achieved while maintaining a certain classification performance. To solve the aforementioned technical problems, embodiments of the present disclosure provide to build on this property that prototypes identify robust positions in the dataset to represent the data. In particular, this means that a prototype tries to identify a position in the dataset so that most data samples that are relevant for the classification task are represented. In general, a prototype will converge to a position where several surrounding data points are similar. In the running example, one patient will be a prototype for the class “has type 2 diabetes” for the diabetes classification task.

For instance, consider the running example: If it is assumed that only 10% of the dataset per class represent people of color, then, after training the prototype-based model with one prototype per class, the classification accuracy of the model would be limited because prototypes will only represent Caucasians as these are the majority (one prototype for risk of type 2 diabetes and one for not at risk). The training of plain prototype models is efficient and fast so that a repeated training of the model is not a limitation. In the second step, embodiments of the present disclosure analyze the obtained prototype-based model with respect to a certain class-wise quality measure, for instance, class-wise (weighted) accuracy (see analyze performance (c) in FIG. 1). If this quality measure for a class is below a certain quality threshold, for example computed on a hold-out dataset (see determination if performance exceeds quality criterion (d) and quality threshold (e) in FIG. 1), a new prototype is added for this class (see add new prototypes for underrepresented classes (f) in FIG. 1) and the model is retrained, in some cases after re-initialization, see training PBL model (b) in FIG. 1). In embodiments, a hold-out dataset may include a dataset that is different from a training dataset but comes from the same distribution. The hold-out dataset may be used to tune certain hyper-parameters. The quality threshold may be determined by an expert manually or in an automatic manner. For example, the quality threshold may be specified by an expert or it may be selected at random. The performance of the model is tested using the hold-out dataset and if the model does not perform as desired, the quality threshold may be changed. In an embodiment, the change may be manual (e.g. performed by the expert) or automatic, such as by applying hyper-parameter tuning strategies like grid search. The model can then be tested iteratively on the hold-out dataset until the model performs according to the quality threshold or some other metric. If there are regions in the dataset that are underrepresented by the previous prototype (subgroups), the new prototype will converge into the region of the subgroup and, thus, represent the underrepresented group (e.g., people of color). After this step, the quality measure is re-evaluated to check if the process should be repeated. In theory, prototype models are Bayes optimal classifiers, which means that if the number of prototypes is high enough, they can represent any data. Therefore, it is provided to stop at a certain point with the addition of prototypes, which is controlled by the quality threshold (e) in FIG. 1.

When the process terminates and enough prototypes have been added automatically to the dataset such that the quality criteria is met, it means that the prototype-based model learned to represent the dataset with the prototypes sufficiently well. This means that the model learned to represent all subgroups sufficiently well with prototypes. In the example, this means people of color and Caucasians. After the training of the prototype model, the number of closest training samples for each prototype is determined (see compute number of closest training samples (g) in FIG. 1), where the samples that surround a prototype are similar with respect to a selected distance measure. Then, the determined number of closest samples determines the sampling probabilities (see compute sampling probabilities (h) in FIG. 1) for the final model by the following equation: Let C be the number of classes, K(c) be the number of prototypes in class c, and M(k, c) be the number of closest training samples in class c with respect to prototype k. Then, the sampling probability (weight) for samples closest to prototype k of class c is determined by:

$$p ( k , c ) = \frac{1}{C} \cdot \frac{1}{K ( c )} \cdot \frac{1}{M ( k , c )} . \qquad ( Eq \text{.1} )$$

Note that M(k, c) only counts training samples that are closest and have the same class label as the prototype (no matter if they have been misclassified by the model). Moreover, the probability over all samples sums up to 1 and the ansatz assumes that each class and prototype is equally likely (important). If this is not suitable, respective prototype or class-specific probabilities can be incorporated. These derived probabilities are finally incorporated into the training pipeline of the final model to ensure a bias free sampling and, therefore, a bias free training of the final model (see debiased model training (i) in FIG. 1).

Advantageously, this process can be automated and does not require human interaction. However, if required, the learned prototypes can be inspected to analyze the identified subgroups to gain further knowledge about potential biases in the dataset. This can be useful to create automatic reports about the dataset so that a bias free training of other models can be achieved more easily and the bias free training is properly documented for an auditing process, for example, in accordance with the European Union (EU) AI Act.

As an additional advantage, the determined sampling probabilities can be used to define bias free performance measures to assess trained models (see determine bias-free performance metrics (k) in FIG. 1). After the probabilities have been determined, they can be used to weight errors in the model such that the final quality metric of the model is sensitive to the identified subgroups. This can be used as a benchmark to measure the bias performance on a training set, which could be, for example, in the form of a biasness score per class (see debiased performance evaluation (j) in FIG. 1). For example, consider a use case of a loan prediction problem. Provided some data bout a user the model should predict whether the person gets a loan from the bank or not This use case includes a problem that has two classes “gets a loan” or “does not get a loan.” A biasness score per class can be determined for each of these classes. For example, if a person is denied a loan, then the classifier's decision is “does not get a loan.” If the biasness score for this data point (loan denied) is 86%, then the decision may be biased in some way (e.g., the classifier might give a lower biasness score simply because a candidate has ethnicity from a minority of a given country).

In research and literature, the technical problem of biased training is frequently investigated. The main method applied is based on Contrastive Data Augmentation (CDA) (see Jieyu Zhao, Tianlu Wang, Mark Yatskar, Vicente Ordonez, and Kai-Wei Chang, “Gender bias in coreference resolution: Evaluation and debiasing methods”, NAACL (2018); and Holtermann, Lauscher, and Ponzetto, “Fair and Argumentative Language Modeling for Computational Argumentation,” ACL (Findings) (2022); each of which is hereby incorporated by reference herein). The idea behind this method is that artificial data is created to reduce the bias. For instance, taking a sentence like “He is a doctor.”, then, during training, replacing “he” by “she” to avoid that the model learns that doctor is always connected with “he.” This method was shown to be efficient in practice. However, it relies on the assumption that the biasing factor can be identified beforehand and that the construction of contrastive examples is possible. In natural language processing, this is often a feasible assumption (e.g., for gender, race, religion, and sexual orientation bias). But it is infeasible, for instance, for the running example as it is unknown how to construct a contrastive example for people of color vs. caucasians on a medical feature level. Moreover, the methods mentioned above always require human interaction and expert knowledge so that the process cannot be fully automated, which also implies that only specific types of biases can be handled. This is another problem solved by embodiments of the present disclosure by proposing a fully automatic and bias-agnostic debiasing process based on prototype-based learning.

Another approach according to existing technology, which provides a general purpose strategy to handle imbalanced (potentially biased) data, is based on unsupervised learning and data point selection (see Edward Schwalb, “Prototyping: Sample Selection for Imbalanced Data,” Conference on Computational Science and Computational Intelligence (2021), which is hereby incorporated by reference herein). One disadvantage of this approach is that it uses an unsupervised approach to identify prototypes, which leads to an incorrect selection strategy for highly nonlinear data. Moreover, in this approach, the prototypes are used to select training samples that should be kept in the final training dataset such that the performance is maximized. Consequently, the goal is not the handling of biased data per se nor the determination of sampling weights so that all training data can be kept, which is important for datasets where minority groups might be represented by a few data points only.

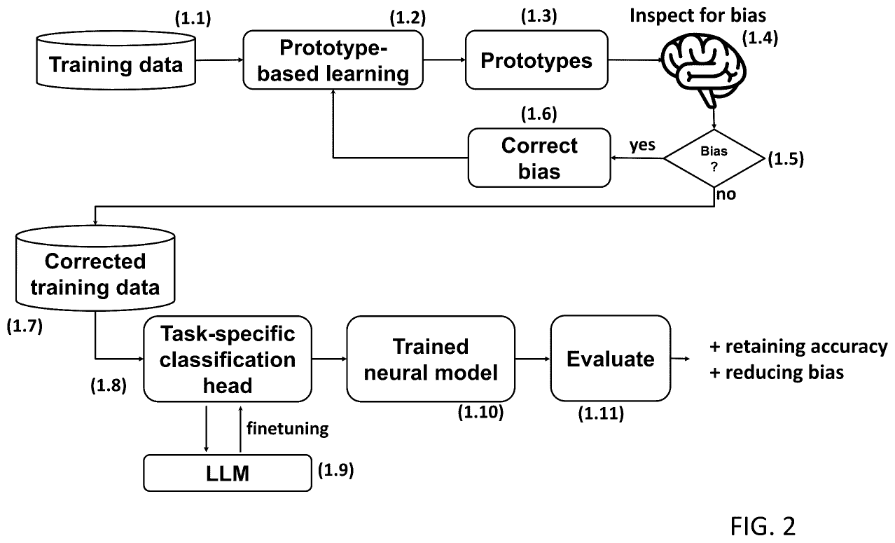

FIG. 2 illustrates a method and system for debiasing training data using prototypes according to an embodiment of the present disclosure. Training data, obtained in step 1.1, could be either for pre-training a large language model (LLM) or task-specific training data for fine-tuning. In step 1.2, training data is obtained from a database and, in step 1.2, prototype-based learning is performed using the training data to generate prototypes in step 1.3. In step 1.4, the prototypes are inspected for bias and a decision is output in step 1.5. If bias is found, it is corrected in step 1.6 and returns to step 1.2. If no bias is found, the corrected training data is stored in a database in step 1.7. A task-specific classification head is trained in step 1.8 and/or an LLM is fine-tuned in step 1.9, providing a trained neural model in step 1.10, which may also be evaluated in step 1.11 for its ability to retain accuracy and reduce bias. In embodiments, the task-specific classification head may be a final layer added on top of the LLM. The weights of the LLM may be fine-tuned such that the task is maximized. The task-specific classification head and the LLM may interact to maximize performance with respect to a given task.

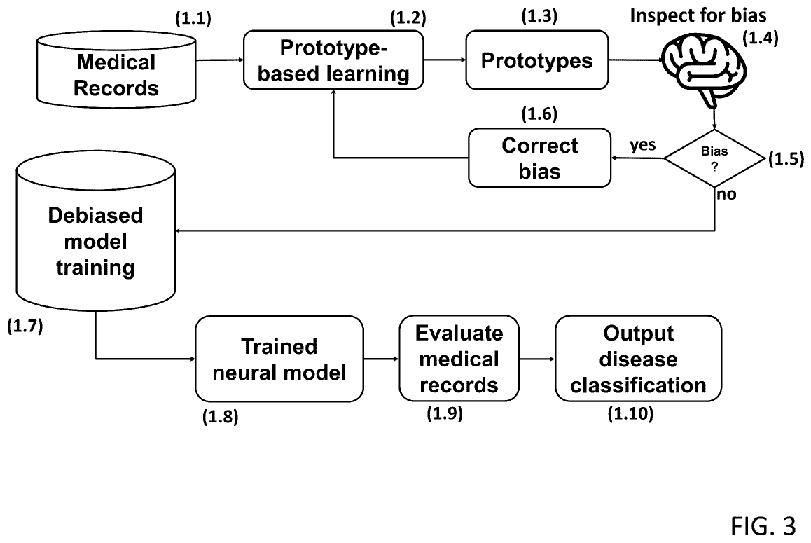

FIG. 3 schematically illustrates a method and system for disease classification from training data including medical records of patients using prototypes according to an embodiment of the present disclosure. Training data, obtained in step 1.1 that includes medical records of patients, could be either or pre-training an LLM or task-specific training data for fine-tuning. In step 1.2, prototype-based learning is performed using the training data to generate prototypes in step 1.3. In step 1.4, the prototypes are inspected for bias and a decision is output in step 1.5. If bias is found, it is corrected in step 1.6, such as by adding a new prototype to the prototype based model for each class of the model which is then retrained using the new prototype. In embodiments, the new prototype is added in response to a class-wise quality metric for a respective prototype per class pair being below a threshold. Once no more bias is found at step 1.5 sample weights for training samples closest to each prototype per class pair are computed and used to do debiased model training at step 1.7 for generating a trained neural model (target model) at step 1.8. The trained neural model of step 1.8 is then used to evaluate at step 1.9 the medical records from step 1.1 to generate or output disease classifications present in the medical records at step 1.10. In embodiments, the trained neural model of step 1.8 may be used to perform automated actions such as diagnosis or treatment, recommendations, hospital bed reservation or planning, prescription filling, etc.

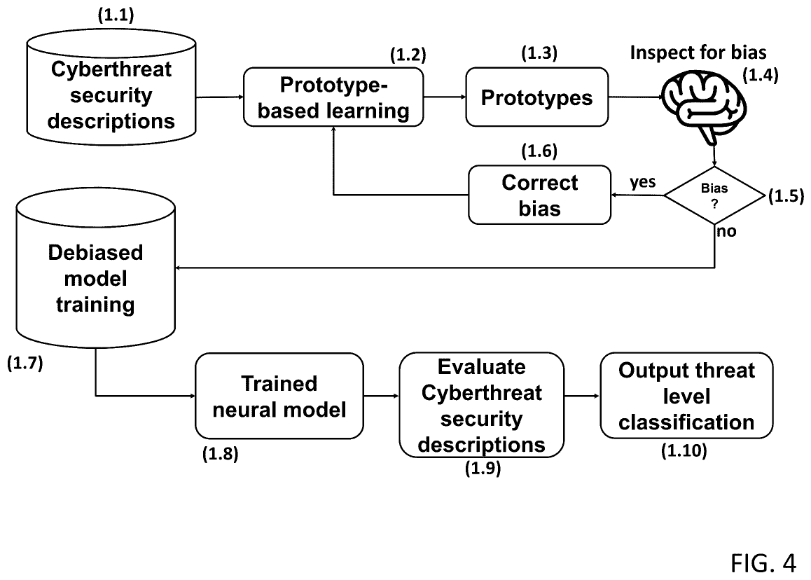

FIG. 4 schematically illustrates a method and system for cyberthreat level classification from training data including cyberthreat security descriptions using prototypes according to an embodiment of the present disclosure. Training data, obtained in step 1.1 that includes cyberthreat security descriptions, could be either or pre-training an LLM or task-specific training data for fine-tuning. In step 1.2, prototype-based learning is performed using the training data to generate prototypes in step 1.3. In step 1.4, the prototypes are inspected for bias and a decision is output in step 1.5. If bias is found, it is corrected in step 1.6, such as by adding a new prototype to the prototype based model for each class of the model which is then retrained using the new prototype. In embodiments, the new prototype is added in response to a class-wise quality metric for a respective prototype per class pair being below a threshold. Once no more bias is found at step 1.5 sample weights for training samples closest to each prototype per class pair are computed and used to do debiased model training at step 1.7 for generating a trained neural model (target model) at step 1.8. The trained neural model of step 1.8 is then used to evaluate at step 1.9 the cyberthreat security descriptions from step 1.1 to generate or output threat level classifications present in the cyberthreat security descriptions at step 1.10. In embodiments, the trained neural model of step 1.8 may be used to perform automated actions such as providing security alerts or taking automated remedial actions to address the identified threats, such as quarantining components or terminating processes or devices.

Embodiments of the present disclosure thus provide for general improvements to computers in machine learning systems to debias training data and generate bias-free models. Moreover, embodiments of the present disclosure can be practically applied to use cases to effect further improvements in a number of technical fields including, but not limited to, medical (e.g., digital medicine, personalized healthcare, AI-assisted drug or vaccine development, etc.), material development, cyberthreat security, policy making, public safety and smart cities.

For example, an embodiment can be applied for disease classification, for instance to a use case as follows:
Use Case: Disease classification is often based on electronic health records as inputs. These inputs are usually not balanced with respect to inputs like the origin. Moreover, the origin is usually not recorded in electronic health records. Therefore, it is a technical challenge to train a bias-free model on such data.
Data Source: Input: medical records of patients.
Application of Embodiment of Method: Application of the method according to an embodiment of the present disclosure on the electronic health records provides to identify subgroups in the dataset such that the target model (disease classification) can be trained bias free.
Output: Sampling weights for each input such that a bias free training and evaluation can be performed. The final model can then be employed for disease classification and automated actions based thereon, such as diagnosis or treatment, recommendations, hospital bed reservation or planning, prescription filling, etc.

As another example, an embodiment can be applied for cyberthreat security, for instance to a use case as follows:
Use Case: Given a cyberthreat security description, the training data is to be debiases and then used to learn a powerful machine learning model to classify the threat level of this description.
Data Source: Input: cyberthreat security descriptions.
Application of Embodiment of Method: Application of the method according to an embodiment of the present disclosure provides to read the data, debias it and then learn a bias-free machine learning model for classifying cyberthreat security reports.
Output: The threat level classification of the cyberthreat security description. The final model can also be employed for automated actions based thereon, such as providing security alerts or taking automated remedial actions to address the identified threats, such as quarantining components or terminating processes or devices.

In an embodiment, the present disclosure provides a method for debiasing training data that is later used for training a final machine learning model (e.g., a deep neural network), the method comprising the steps of:
1. Defining a class-wise quality metric and a quality threshold for the debiasing framework (see quality threshold (e) in FIG. 1). In an embodiment, the class-wise quality metric and the quality threshold may be specified by an expert upfront and may depend on the task at hand. For example, if the task is to predict whether a person will get loan from the bank, a quality threshold could be something as follows: if the bias score is above 0.8, then it is classified as biased. Or, it could be dependent on certain conditions. For example, if we remove features from the person (e.g., income, job title, etc.) and we only leave the features such as race and gender, if the classifier gives different answer, then it is clearly biased.
2. Training a prototype-based model with one prototype per class (see training PBL model (b) in FIG. 1).
3. Analyzing the model with respect to the quality metric and the threshold (see analyze performance (c) in FIG. 1). If the threshold is not exceeded for at least one class, continue to 4; otherwise, go to go to step 5 (see determination whether performance exceeds quality criterion (d) in FIG. 1). In an embodiment the threshold is specified by an expert upfront.
4. Adding one prototype for the classes where the threshold was not exceeded and retraining the prototype-based model (see add new prototypes for underrepresented classes (f) in FIG. 1). Then, go back to step 3.
5. Computing the number of closest samples to each prototype that have the correct class label denoted as M(k, c) (see compute number of closest training samples (g) in FIG. 1). Using this number M(k, c), the sample weights are computed according to Eq. 1 (see compute sampling probabilities (h) in FIG. 1). In embodiments, a distance measure for determining closest samples may include any relevant measure that computes a distance between vectors in an embedding space (e.g., cosine similarity or Euclidean distance).
6. Training the target model and performing a weighted sampling according to the computed sampling weights to ensure that the model is not biased (see debiased model training (i) in FIG. 1). As an example a weighted sampling may include assuming that you have a dataset consisting of 10 samples of class A and 90 samples of class B. Usually, samples are drawn from class A and B with the same probability (so consider a joint dataset A+B and pick and random sample). This leads to the situation that 90% of the random samples will be from class B and 10% from class A. Hence, during the training samples of class A will be underrepresented. To solve this, one can perform a weighted sampling, which assumes that the importance of each class is equivalent. So during the sampling, in a first step it is sampled from which class the sample should be (50-50 chance). Then, a sample from the selected class is drawn. By this approach both classes are represented equally likely.
7. Evaluating the target model with respect to an unbiased performance metric by using the determined sampling weights (see debiased performance evaluation (j) in FIG. 1). As an example to describe an unbiased performance metric consider a situation as described above with two classes, class A and B. If the native accuracy over this kind of dataset is computed by only predicting class B a classifier achieves a good accuracy of 90% even if it does not know anything about class A. If, however, sampling weights are utilized, one can compute an unbiased score. In a simplest case this is called a balanced accuracy, which respects that there are two classes and one class is completely misclassified (balanced accuracy=50%). In scenarios where the system has individual sampling weights and wants to compute an accuracy that respects these weights, all the probabilities according to Eq. 1 may be summed for which the classification is correct.

Embodiments of the present disclosure provide for the following improvements and technical advantages over existing technology:
1) Training of a prototype-based learning method with an adaptive number of prototypes based on a quality criterion to automatically identify subgroups in the dataset (see steps/modules (b), (c), (d), (e) and (f) in FIG. 1).
2) Utilizing the number of closest samples to each prototype as a quantity to:
   a) initialize a weighted sampling procedure such that the target model can be trained bias free (see steps/modules (g) and (h) in FIG. 1).
   b) define a bias-free performance measure (see steps/modules (k) and (j) in FIG. 1).
3) Enabling to remove bias in a fully automated fashion. In contrast, current debiasing strategies require human interaction or input, for instance, in the form of the definition of templates such that artificial data points can be created to balance the data. This limits their applicability in general and also adds the risk that the human subjectivity influences this process. In embodiments of the present disclosure, the process is fully automatic and performs a clever sampling of the data to remove the bias. Additionally, embodiments of the present disclosure have the advantage that automatic reports can be generated and that the determined probabilities can be used to define a bias-free performance measure. These are significant technological improvements over existing technology.

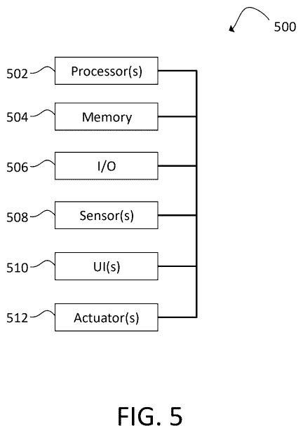

Referring to FIG. 5, a processing system 500 can include one or more processors 502, memory 504, one or more input/output devices 506, one or more sensors 508, one or more user interfaces 510, and one or more actuators 512. Processing system 500 can be representative of each computing system disclosed herein.

Processors 502 can include one or more distinct processors, each having one or more cores. Each of the distinct processors can have the same or different structure. Processors 502 can include one or more central processing units (CPUs), one or more graphics processing units (GPUs), circuitry (e.g., application specific integrated circuits (ASICs)), digital signal processors (DSPs), and the like. Processors 502 can be mounted to a common substrate or to multiple different substrates.

Processors 502 are configured to perform a certain function, method, or operation (e.g., are configured to provide for performance of a function, method, or operation) at least when one of the one or more of the distinct processors is capable of performing operations embodying the function, method, or operation. Processors 502 can perform operations embodying the function, method, or operation by, for example, executing code (e.g., interpreting scripts) stored on memory 504 and/or trafficking data through one or more ASICs. Processors 502, and thus processing system 500, can be configured to perform, automatically, any and all functions, methods, and operations disclosed herein. Therefore, processing system 500 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 500 can be configured to perform task “X”. Processing system 500 is configured to perform a function, method, or operation at least when processors 502 are configured to do the same.

Memory 504 can include volatile memory, non-volatile memory, and any other medium capable of storing data. Each of the volatile memory, non-volatile memory, and any other type of memory can include multiple different memory devices, located at multiple distinct locations and each having a different structure. Memory 504 can include remotely hosted (e.g., cloud) storage.

Examples of memory 504 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 504.

Input-output devices 506 can include any component for trafficking data such as ports, antennas (i.e., transceivers), printed conductive paths, and the like. Input-output devices 506 can enable wired communication via USB®, DisplayPort®, HDMI®, Ethernet, and the like. Input-output devices 506 can enable electronic, optical, magnetic, and holographic, communication with suitable memory 506. Input-output devices 506 can enable wireless communication via WiFi®, Bluetooth®, cellular (e.g., LTE®, CDMA®, GSM®, WiMax®, NFC®), GPS, and the like. Input-output devices 506 can include wired and/or wireless communication pathways.

Sensors 508 can capture physical measurements of environment and report the same to processors 502. User interface 510 can include displays, physical buttons, speakers, microphones, keyboards, and the like. Actuators 512 can enable processors 502 to control mechanical forces.

Processing system 500 can be distributed. For example, some components of processing system 500 can reside in a remote hosted network service (e.g., a cloud computing environment) while other components of processing system 500 can reside in a local computing system. Processing system 500 can have a modular design where certain modules include a plurality of the features/functions shown in FIG. 5. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention or disclosure is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for training of a machine learning model, the computer-implemented method comprising:
analyzing a prototype-based model with at least one prototype per class based at least in part on a comparison between a class-wise quality metric and a threshold for each prototype per class pair of the prototype-based model;
adding for each class a new prototype in response to the class-wise quality metric for a respective prototype per class pair being below the threshold;
retraining the prototype-based model using the new prototype;
counting a number of training samples closest to each prototype per class pair of the retrained prototype-based model based on a distance measure;
computing sample weights for the training samples closest to each prototype per class pair based on the number; and
training a target model using the computed sample weights.

2. The computer-implemented method according to claim 1, wherein computing the sample weights for the training samples is further based on an equation including:
$$p ( k , c ) = \frac{1}{C} \cdot \frac{1}{K ( c )} \cdot \frac{1}{M ( k , c )} ,$$
where C is a number of classes, K(c) is a number of prototypes in class c, M(k,c) is a number of training samples in the class c with respect to prototype k, and p(k,c) is the sample weights.

3. The computer-implemented method according to claim 1, wherein analyzing, adding, and retraining steps are iteratively repeated until the class-wise quality metric for each prototype per class pair of the retrained prototype-based model exceeds the threshold.

4. The computer-implemented method according to claim 1, wherein the prototype-based model is initially trained with a set of training data for a classification task, wherein the training samples are derived from the set of training data, and wherein training the target model using the computed sample weights includes using the set of training data.

5. The computer-implemented method according to claim 1, wherein the class-wise quality metric is computed on a hold-out dataset.

6. The computer-implemented method according to claim 1, further comprising performing a weighted sampling of the trained target model using the computed sample weights.

7. The computer-implemented method according to claim 1, further comprising determining an unbiased performance metric using the computed sample weights.

8. The computer-implemented method according to claim 7, further comprising measuring bias performance on a set of training data using the unbiased performance metric, wherein the set of training data is used for initially training the prototype-based model, wherein the bias performance includes a biasness score per class of the set of training data.

9. The computer-implemented method according to claim 1, wherein the retrained prototype-based model identifies subgroups in a set of training data.

10. The computer-implemented method according to claim 1, further comprising generating a report that includes learned prototypes and identified subgroups of the learned prototypes of the trained target model.

11. The computer-implemented method according to claim 1, further comprising, prior to retraining the prototype-based model using the new prototype, re-initializing the prototype-based model.

12. The computer-implemented method according to claim 1, further comprising receiving medical records of patients, wherein the prototype-based model is initially trained using the medical records of patients, and wherein the trained target model identifies disease classifications in the medical records of patients.

13. The computer-implemented method according to claim 1, further comprising receiving descriptions of cyber threat security issues, wherein the prototype-based model is initially trained using the descriptions of cyber threat security issues, and wherein the trained target model identifies threat level classifications for each cyber threat security description of the descriptions of cyber threat security issues.

14. A computer system for training of a machine learning model, the computer system comprising one or more hardware processors which, alone or in combination, are configured to provide for execution of the following steps:
analyzing a prototype-based model with at least one prototype per class based at least in part on a comparison between a class-wise quality metric and a threshold for each prototype per class pair of the prototype-based model;
adding for each class a new prototype in response to the class-wise quality metric for a respective prototype per class pair being below the threshold;
retraining the prototype-based model using the new prototype;
counting a number of training samples closest to each prototype per class pair of the retrained prototype-based model based on a distance measure;
computing sample weights for the training samples closest to each prototype per class pair based on the number; and
training a target model using the computed sample weights.

15. A tangible, non-transitory computer-readable medium having instructions thereon which, upon being executed by one or more processors, provide for training of a machine learning model by execution of the following steps:
analyzing a prototype-based model with at least one prototype per class based at least in part on a comparison between a class-wise quality metric and a threshold for each prototype per class pair of the prototype-based model;
adding for each class a new prototype in response to the class-wise quality metric for a respective prototype per class pair being below the threshold;
retraining the prototype-based model using the new prototype;
counting a number of training samples closest to each prototype per class pair of the retrained prototype-based model based on a distance measure;
computing sample weights for the training samples closest to each prototype per class pair based on the number; and
training a target model using the computed sample weights.
